(19) United States
(12) Patent Application Publication
(10) Pub. No.: US 2021/0331004 A1
(43) Pub. Date: Oct. 28, 2021

(54) PROTECTIVE EQUIPMENT

(71) Applicant: LevMarc LLC, Milford, CT (US)

(72) Inventors: Steven Brian Levine, Weston, CT (US); Jenna M Levine, Weston, CT (US)

(73) Assignee: LevMarc LLC, Milford, CT (US)

(21) Appl. No.: 17/238,259

(22) Filed: Apr. 23, 2021

Related U.S. Application Data
(60) Provisional application No. 63/025,206, filed on May 15, 2020.
(60) Provisional application No. 63/015,787, filed on Apr. 27, 2020.

(51) Int. Cl. A62B 18/08; A41D 13/11; B01D 46/00; A62B 9/02; A62B 23/02; A62B 18/02

(52) U.S. Cl. CPC A62B 18/08; A41D 13/1107; B01D 46/0019; B01D 2279/40; A62B 23/025; A62B 18/02; A62B 9/02

(57) ABSTRACT

A protective equipment includes a face shield configured for being worn by a patient to minimize exposure of a healthcare worker to the patient's bodily fluids, bacteria and/or viruses. The face shield includes a body having an upper peripheral edge and a lower peripheral edge. At least one port is formed in the body. The protective equipment may include a barrier positioned in the port. The protective equipment may further include an extended member secured to the lower peripheral edge of the face shield, and configured to substantially inhibit or trap micro aerosolized particles from traversing the extended member. The protective equipment includes an air flow system configured to receive and filter air from an environment external to the face shield and pull the patient's expelled air away from the patient's face and filter or clean the expelled air.

### CROSS-REFERENCE TO RELATED APPLICATIONS

This application claims the benefit of U.S. Provisional Application No. 63/025,206 filed May 15, 2020 and U.S. Provisional Application No. 63/015,787 filed Apr. 27, 2020, each of which is incorporated herein by reference in its entirety.

### BACKGROUND OF THE DISCLOSURE

Healthcare workers/providers typically wear various protective gear when caring for patients with certain diseases and viral infections, in order to reduce the healthcare workers potential risks of contracting such diseases and viral infections. Core practices currently implemented include the healthcare worker's use of protective eyewear, and a mask or face shield, to protect the mucous membranes of their eyes, nose and mouth during any procedures and activities likely to generate any splashes or sprays of any secretions, bodily fluids, blood, and the like from patients being attended to.

Face shields, in particular, are commonly used by healthcare workers who take care of novel coronavirus (COVID-19) patients and those with potential COVID-19 infections. The virus that causes COVID-19 may be transmitted through droplets generated when an infected person coughs, sneezes, or speaks. Because a significant reservoir of the novel coronavirus responsible for COVID-19 is within the nasal cavity, nasopharynx, oropharynx and larynx, specialists in Otolaryngology-Head & Neck Surgery (Ear, Nose & Throat or ENT) and Dental Medicine who perform procedures on these anatomic regions may have significant work-related exposure to such viral particles and patients having such procedures performed are also at risk of exposure.

Such face shields 10 are illustrated in FIGS. 1 and 2 of the figures and typically include a solid plastic sheath 20 that extends from or is attached to a securing mechanism 30. FIG. 2 illustrates that the securing mechanism may wrap around the heard of a healthcare worker. In order to provide additional protection to the healthcare worker, the healthcare worker may also wear a face mask 40 to cover his/her mouth and nose.

While healthcare workers/providers wear various protective gear to reduce their risk of exposure, the patient may be left exposed to any diseases and viral infections that can be transmitted from the healthcare workers tending to the patient. In addition, should the protective gear being worn by the healthcare worker fail, there may be no additional measures for protecting the patient and the healthcare worker from any airborne viruses and/or bacteria that may be in the room.

It has been recommended that some medical offices be configured as Airborne Infection Isolation Rooms (AIIR) (also referred to as negative pressure rooms or areas) for the performance of medical procedures. AIIR serve to trap any potential harmful airborne viruses and/or bacteria and prevent those airborne viruses and/or bacteria from leaving the space of the AIIR, thereby isolating anyone outside the room from exposure to the patient's airborne viruses and/or bacteria. Such AIIR are expensive to build and retrofit to medical buildings and facilities. In addition, they can be cost prohibitive for mid-size and small medical practices.

Accordingly, there is a need for a protective equipment that can be worn by the patient to protect the patient and/or healthcare workers from diseases and viral infections. There is a further need for a protective equipment that can be worn by the patient to protect the patient and healthcare workers from diseases and viral infections while the patient undergoes medical procedures. There is a further need for a disposable protective equipment that provides a personalized negative pressure protective equipment for each patient.

### BRIEF DESCRIPTION OF THE EXEMPLARY EMBODIMENTS

According to an aspect, the exemplary embodiments include a protective equipment. The protective equipment includes a face shield including a body having an upper peripheral edge and a lower peripheral edge. At least one port is formed in the body. According to an aspect, the port is spaced apart from the upper peripheral edge and the lower peripheral edge. The protective equipment may further include an extended member secured to the lower peripheral edge of the face shield. The extended member may be particularly suited for substantially inhibiting or trapping micro aerosolized particles from traversing the extended member.

In another aspect, the exemplary embodiments include a protective equipment including a face shield and at least one port. The face shield and the at least one port may be substantially configured as described hereinabove. According to an aspect, the protective equipment further includes a barrier positioned in the least one port.

Further embodiments of the disclosure are associated with a protective equipment including a face shield and an airflow system. The face shield may be configured substantially as described hereinabove. The face shield includes an upper peripheral edge having a first end and a second end spaced apart from the first end. A circumferential edge portion extends between the first end and the second end of the upper peripheral edge of the face shield. The airflow system includes an air valve positioned adjacent the upper peripheral edge of the body of the face shield, and an air outlet positioned adjacent a lower portion/lower peripheral edge of the circumferential edge portion of the face shield. The air valve is configured to receive and filter air from an environment external to the face shield, and the air outlet is configured to pull air expelled by the patient away from the patient's face and filter/clean the expelled air.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 is a perspective view of a face shield being worn by a healthcare provider, according to the prior art;

FIG. 2 is a perspective view of a face shield configured to be worn by a healthcare provided, according to the prior art;

FIG. 3 is a perspective view of a protective equipment including a face shield that includes a plurality of ports, according to an embodiment;

FIG. 4A is a perspective view of a barrier configured for use with the face shield of FIG. 3;

FIG. 4B is a cross-sectional view of the barrier of FIG. 4A, illustrating upper and lower barriers according to an embodiment;

FIG. 5 is a perspective view of a shoulder harness for use with a face shield, according to an embodiment;

FIG. 6 is a front view of a protective equipment including a face shield and an air flow system, according to an embodiment;

FIG. 7 is a perspective view of a protective equipment including a face shield and an air flow system, according to an embodiment;

FIG. 8 is a side view of a protective equipment including a face shield for being secured to a user's head, and an air flow system and an extended member, according to an embodiment;

FIG. 9 is a perspective view of a protective equipment including a face shield for being positioned over a patient's head, an air flow system and an extended member, according to an embodiment;

FIG. 10 is a perspective view of a protective equipment including a face shield and an air flow system, illustrating the protective equipment in use, according to an embodiment; and

FIG. 11 is a perspective view of the protective equipment of FIG. 10 including an air filtration system, according to an embodiment.

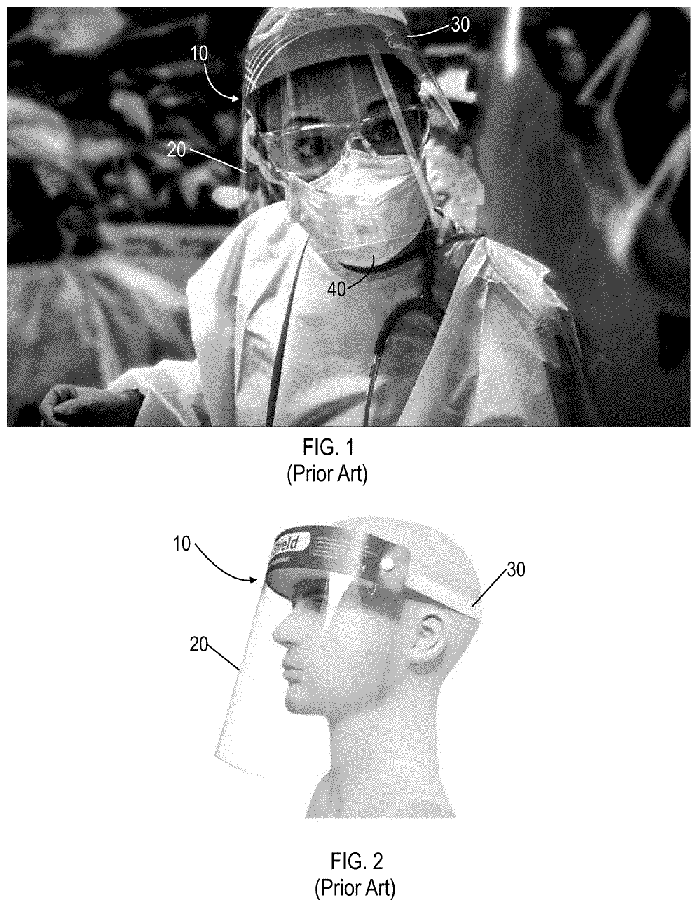

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to emphasize specific features relevant to some embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various embodiments. Each example is provided by way of explanation and is not meant as a limitation and does not constitute a definition of all possible embodiments.

Embodiments described herein relate generally to protective equipment that is particularly suited for patients undergoing medical procedures related to the ear, nose, and oral cavities (including the throat). To be sure, the protective equipment described herein may also be used by persons who are not undergoing medical procedures, but persons seeking additional protection against the transmission or contraction of various viral and bacterial infections, such airborne viral and bacterial infections.

For purposes of illustrating features of the embodiments, exemplary embodiments are introduced and referenced throughout the disclosure. These embodiments are illustrative and not limiting and are provided for illustrating the exemplary features of a protective equipment as described throughout this disclosure.

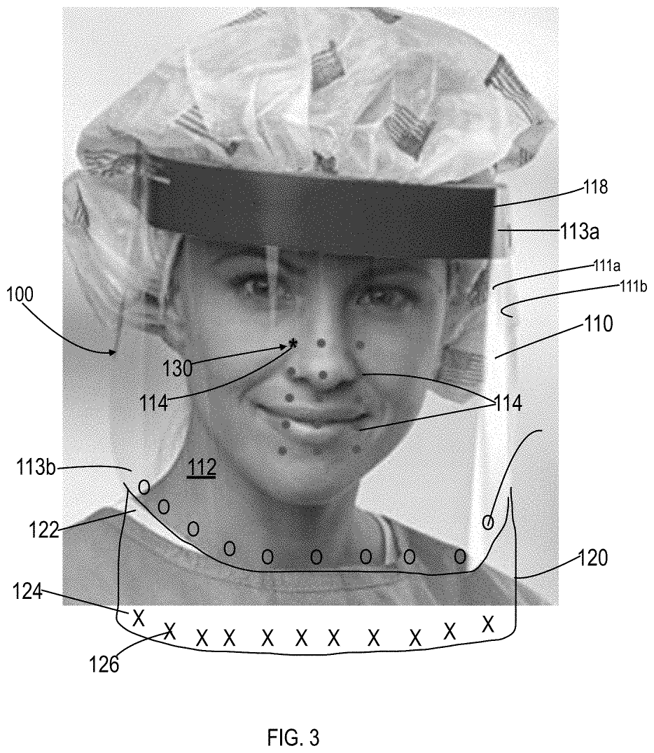

FIG. 3 and FIGS. 6-11 each illustrate a protective equipment 100. The protective equipment 100 includes a face shield 110. The face shield is 110 configured for being worn by a patient to minimize exposure of a healthcare worker to the patient's bodily fluids, bacteria and/or viruses. The face shield 110 includes a body 112 having an inner surface 111a facing the patient and an outer surface 111b opposite the patient. The body 112 further includes an upper peripheral edge 113a and a lower peripheral edge 113b spaced apart from the upper peripheral edge 113a. The face shield 110 may include a securing mechanism 118, such as a strap, at the upper peripheral edge 113a to help secure the body 112 of the face shield 110 to the patient. Alternatively, the face shield 110 may be contoured so that it fits around a portion of the patient's head, without a separate securing mechanism.

In an embodiment, at least a portion of the face shield 110 is transparent. At least a portion of the face shield 110 may be opaque. The face shield 110 may be fully transparent, partially transparent, or fully opaque. According to an aspect, the face shield 110 includes at least a portion that is transparent, such as the area around the patient's eyes, ears, or mouth. The face shield 110 may include a transparent portion around the patient's eyes so that the patient can see through it.

The face shield 110 may be composed of a number of materials. According to an aspect, the face shield 110 includes a thermoplastic or thermoset film. According to an aspect, the face shield 110 includes a fibrous material. The face shield 110 may include polyester, such as polyethylene terephthalate (PET), polystyrene-co-polyacrylonitrile, polyolefins, such as polyethylene or their copolymers, polycarbonate, polyacrylates, such as polymethyl methacrylate, polyethyl acrylate or their copolymers, polysulfone.

As illustrated in FIGS. 3, 7 and 8, the face shield 110 may further include a port 114 formed in the body 112 of the face shield 110. According to an aspect, the port 114 is disposed between the upper peripheral edge 113a and the lower peripheral edge 113b. The port 114 may also extend between the inner surface 111a and the outer surface 111b of the face shield 110. The positioning of the port 114 provides entrance by one or more instruments through the face shield 110 thereby providing access to the patient while protecting the healthcare worker from the patient's bodily fluids, bacteria and/or viruses. In other words, the port 114 helps to facilitate access to the patient's orifices during medical procedures being performed by a health care provider.

According to an aspect, the port 114 has an inner diameter of up to about 0.5 centimeters (cm). The port 114 may include a plurality of ports 114, each port 114 of the plurality of ports 114 being configured substantially as described hereinabove. In this configuration, each port 114 is spaced apart from another port 114 by at distance between about 0.5 cm and about 2.0 cm. In order to facilitate access to the nose or oral cavity, the face shield 110 may include rows of ports 114 that accommodate instruments having an outer diameter of up to about 0.5 cm in diameter. The ports 114 may be positioned in the sides of the face shield 110 to facilitate access to the ear of the patient.

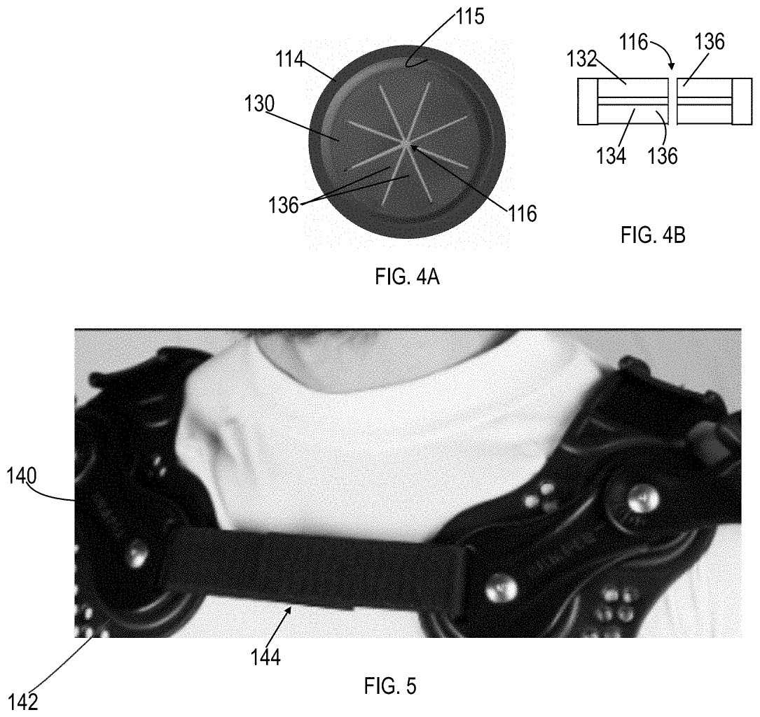

FIG. 3 illustrates the protective equipment 100 including a barrier 130 positioned in the port 114. The barrier 130 is shown in more detail in FIG. 4A and FIG. 4B. The barrier 130 includes a periphery 115 and a plurality of deformable protrusions/bristles 136 extending away from the periphery 115 towards a centralized location 116 of the port 114. The barrier 130 may help to secure instruments as they pass through the ports 114 of the face shield 110. According to an aspect, the deformable protrusions of the barrier 130 bend and conform to the instrument as the port 114 is being accessed.

The barrier 130 may include a polymeric material or a copolymer. According to an aspect, the polymeric material includes rubber, silicone, or polypropylene. As would be understood by one of ordinary skill in the art, the barrier 130 may be composed of any material that is sufficiently deformable to provide access to the patient's facial orifices when an instrument is positioned therethrough, but sufficiently stiff so that it closes the gap between the instrument and the periphery 115 of the port 114.

According to an aspect, the plurality of protrusions 136 comprises multiple flexible layers. As illustrated in FIG. 4B, the barrier 130 may include an upper barrier 132 and a lower barrier 134, with each of the upper barrier and the lower barrier including the plurality of deformable protrusions 136. The protrusions 136 of one barrier may vary in size, shape, material, and quantity from the protrusions 136 of other barriers 130. According to an aspect, for barriers 130 having upper and lower barriers 132, 134, the protrusions 136 may be aligned. Alternatively, the barriers 130 may vary in orientation so that the protrusions 136 are misaligned and are diametrically opposite to each another (not shown).

According to an aspect, the protective equipment 100 further includes an extended member 120 secured to the lower peripheral edge 113b of the face shield 110. The extended member 120 may include a flexible and breathable material configured to substantially inhibit or trap micro aerosolized particles from traversing the extended member 120.

The extended member 120 includes a first end 122 secured to the lower peripheral edge of the face shield, and a second end 124 spaced apart from the first end. The first end 122 is removably secured to the lower peripheral edge 113b of the face shield 110. The first end 122 may be permanently secured to the lower peripheral edge 113b of the face shield 110. According to an aspect, the first end 122 is secured to the lower peripheral edge 113b in such a manner as to minimize the release of micro-aerosolized particles when the patient coughs, sneezes, or exhales, or when inhibit the contamination of the patient of micro aerosolized particles when the healthcare provider coughs, sneezes, or exhales. It is contemplated that the protective equipment 100 may inhibit up to about 95% of micro aerosolized particles from traversing the protective equipment 100.

According to an aspect, the second end 124 of the extended member 120 includes a securing mechanism 126. The securing mechanism 126 is configured to secure the extended member 120 to a body portion of the patient in order to further limit micro aerosolized particles traversing the protective equipment 100. The securing mechanism 126 may include at least one of a pressure sensitive adhesive or weights. When the securing mechanism 126 includes the pressure sensitive adhesive, the second end 124 may be taped to the patient's skin.

According to an aspect and as illustrated in FIG. 5, the protective equipment 100 further comprises a shoulder harness 140. The shoulder harness 140 includes a body portion 142. In an embodiment, the body portion 142 of the shoulder harness 140 is couplable to the extended member 120. The shoulder harness may be frictionally or gravitationally secured to at least a portion of the extended member 120. According to an aspect, the body portion 142 of the shoulder harness 140 includes one or more of a hook, a clamp, a fastener and a snap to attach the shoulder harness 140 to the second end 124 of the extended member 120. This may help to mitigate the release of any exhaled aerosolized particles by the patient into the surrounding environment.

The shoulder harness 140 may further include straps 144 to help secure the shoulder harness 140 to the patient's shoulders. The straps 144 may be configured with Velcro or any other fasteners to ensure that the shoulder harness 140 cannot be accidentally released from the patient's shoulders.

One or more portions of the shoulder harness 140 may include a plastic material or a fibrous material. According to an aspect, the body portion 142 of the shoulder harness 140 includes a plastic material and the straps include a fibrous material.

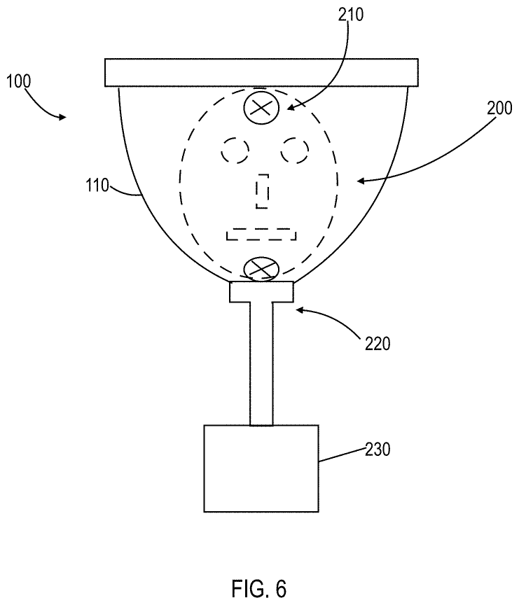

Embodiments of the disclosure are further associated with a protective equipment 100 including a face shield 110 and an air flow system 200. FIGS. 6-11 illustrate the protective equipment 100 in detail.

The face shield 110 may be configured substantially as described hereinabove and illustrated in FIG. 3, thus for purposes of convenience and limitation, the various features and aspects of the face shield 110 are not repeated hereinbelow with respect to FIGS. 6-11.

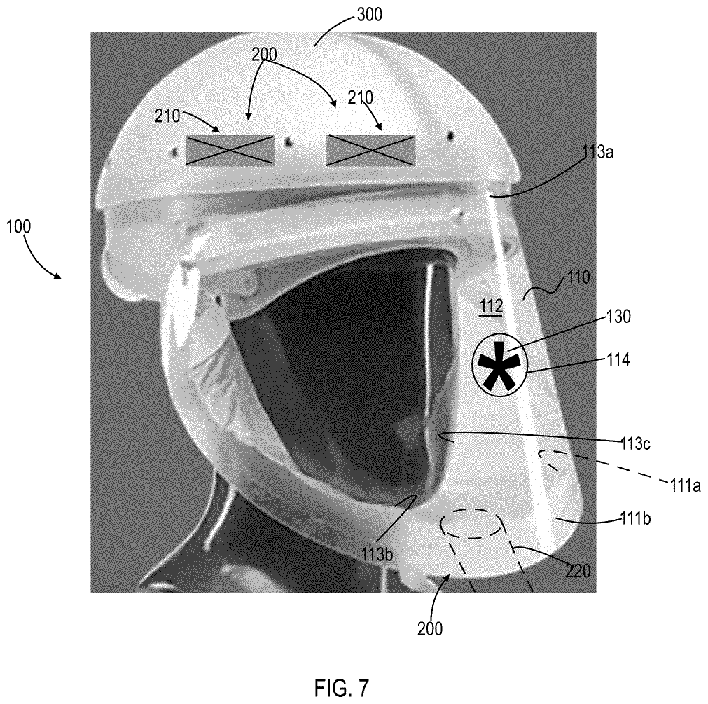

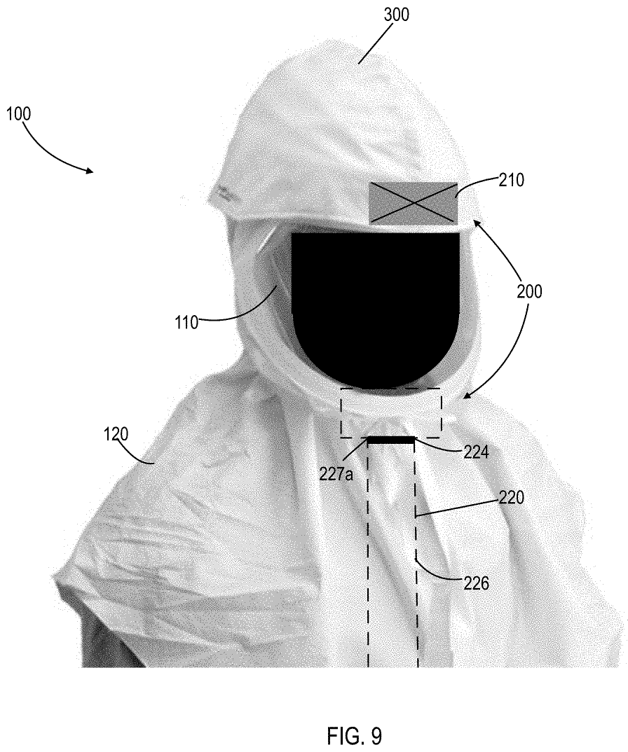

The face shield 110 includes a body 112 having an upper peripheral edge 113a having a first end 117a and a second end 117b. A circumferential edge portion 113c extends between the first end 117a and the second end 117b. The circumferential edge portion 113c includes a lower portion/lower peripheral edge 113b. According to an aspect, at least a portion of the circumferential edge portion 113c is contoured to the patient's head or face. As illustrated in FIG. 7 and FIG. 9, the face shield 110 may include a head covering portion 300 that configured to cover the crown of a patient's head. The head covering portion 300 is coextensive with the body 112 of the face shield 100, with no gaps between them so that air flow is inhibited where the head covering potion 300 and the body 112 of the face shield 110 are conjoined or connected.

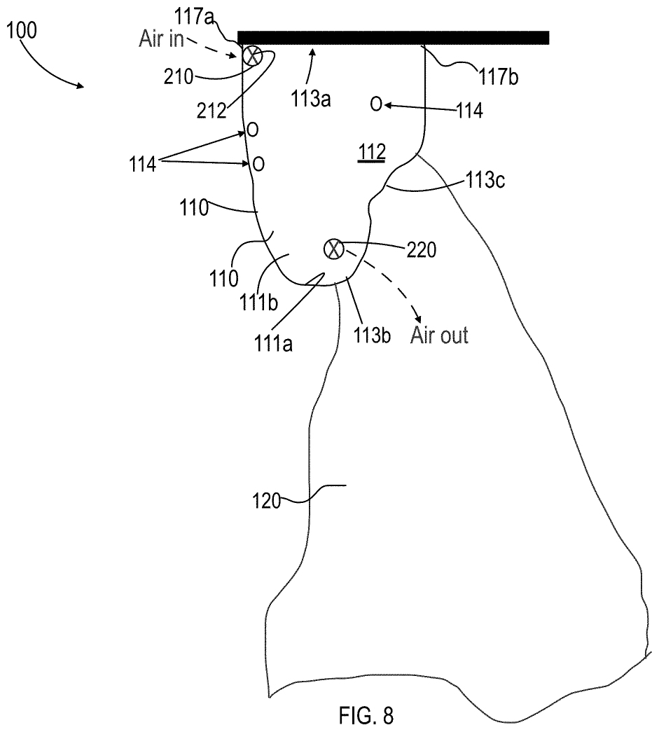

The face shield 110 is configured for being worn by a patient to minimize exposure of a healthcare worker to the patient's bodily fluids, bacteria and/or viruses. The body 112 of the face shield 110 further includes an inner surface 111a and an outer surface 111b. When the face shield 110 is being worn by the patient, the inner surface 111a faces the face of the patient, such that the inner surface 111a is exposed to the air expiry of the patient. On the other hand, the outer surface 111b is opposite the face of the patient and is open to the environment. The face shield 110 may be generally contoured to fit the patient's face, while also leaving a space or gap between the patient's face and the inner surface 111a of the body 112 to ensure that sufficient space is provided to facilitate the flow of air. According to an aspect, the upper peripheral edge 113a and the circumferential edge portion 113c is contoured to at least a portion of the patient's head. According to an aspect and as illustrated in FIG. 7 and FIG. 8, the circumferential edge portion 113c is contoured to the patient's face. The face shield 110 may be configured such that it creates an environment internal (i.e., an internal environment) to the face shield that is subjected to the patient's air expiry and separates that internal environment from areas external to the face shield (for example, the room or area where the patient is located, such as a medical treatment room, ENT's office or dental office).

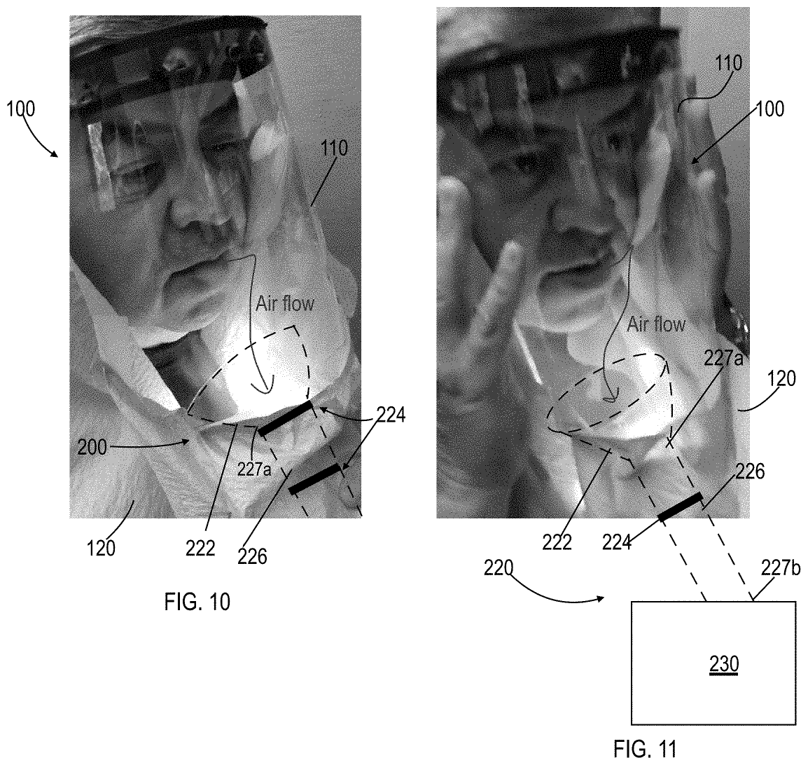

According to an aspect and as illustrated in FIGS. 8-11, the protective equipment 100 further includes an extended member 120. The extended member 120 may be secured to the circumferential edge portion 113c of the body 112 of the face shield 110. According to an aspect, the extended member 120 is secured to at least the lower peripheral edge 113b of the body 112 of the face shield 110 (see, for example, FIG. 9 and FIG. 10). The extended member 120 may be configured substantially as described hereinabove and illustrated in FIG. 3. Thus, for purposes of convenience and not limitation, the various features and aspects of the extended member 120 are not repeated hereinbelow.

The extended member 120 may either drape on top of or around the patient's body in order to cut off air flow so that it only goes through the face shield 110. According to an aspect as illustrated in FIG. 8-FIG. 11, the extended member is adhered to or otherwise secured to circumferential edge portion 113c. The extended member may be cuffed or tucked under the circumferential edge portion 113c in order to further limit the flow of air away from areas external to the face shield 110.

The air flow system 200 is illustrated in FIGS. 6-11. The air flow system is in communication with the internal environment of the face shield 110. This internal environment will essentially include any air being breathed out by the patient and potential droplets associated with the patient's breath, the patient's saliva and any fluids that may be associated with the patient's maxillofacial areas and the patient's ears. The air flow system 200 includes an air valve/intake valve 210 and an air outlet 220 spaced apart from the intake valve 210. The air outlet 220 may further be connected to air filtration system 230.

The intake valve 210 is positioned adjacent the upper peripheral edge 113a of the body 112. The air valve 210 may be movable between open and closed positions. The intake valve 210 may also be configured to receive and filter air from the environment external to the face shield 110. According to an aspect, the air valve 210 is a passive valve that receives air from the external environment. In this configuration, the air valve 210 only operates when air is pulled through it—this can occur when the patient breathes in or when air is pulled by a vacuum by an air outlet mechanism (described in further detail hereinbelow). A user, such as the patient, may take normal breaths, without having air being forced into the internal environment of the face shield 110. The air valve 210 may be equipped with one or more filters 212 configured to filter the air from the environment external to the face shield 110 prior to the filtered air being received into the internal environment.

The air outlet 220 is positioned adjacent a lower portion/lower peripheral edge 113b of the circumferential edge portion 113c. The air outlet 220 may be configured to pull, via a vacuum-type suction or pull, the air expelled by the patient away from the patient's face and filter/clean the expelled air. When the patient exhales, the exhaled/expelled air only travels to the air outlet 220 where it can be filtered. The expelled air may be transported in a direction towards the extended member 120.

The intake valve 210 and the air outlet 220 work together such that when a patient breathes in, the patient has access to air form an environment external to the face shield 110, and when a patient breathes out, the vacuum-configured air outlet 220 pulls the expired air away from the face shield 110 so the expired air can be filtered. The path of the patient's inhaled air and exhaled air, when wearing the protective equipment 100 including the face shield 110 and the air flow system 200, may be function similar to the flow path of air in a negative pressure room. As would be understood by one of ordinary skill in the art, the air flow system 200 facilitates the entrance of air into the face shield 110 so the patient can inhale the air, then pulls the patient's exhaled air out of the face shield 110. After the expired air is filtered by one or more filters 224 (FIGS. 9-10), the filtered expired air may be released back into the environment external to the face shield 110.

As illustrated in FIG. 7 and FIG. 8, the air outlet 220 may include an air suction conduit 222. The air suction conduit 222 may include a hose 226. The hose 226 may include a plastic or metal material. According to an aspect, the hose 226 is composed on an NSF safe material. The hose 226 includes a first end 227a and a second end 227b. One or more second filters 224 may be disposed within the hose 226 at one of the first end 227a, the second end 227b, and any position between the first and second ends 227a, 227b. According to an aspect, the first end 227a of the hose 226 is connected to the lower portion 113b of the circumferential edge portion 113c of the body 112, such that the hose 226 is in communication with the internal environment of the face shield 110.

The second end 227b of the hose 226 may be connected to the air valve 210 positioned adjacent the upper peripheral edge 113a of the body 112 (not shown). According to an aspect and as illustrated in FIG. 8, the second end 227b of the hose 226 may be connected to an air filtration system 230. The air filtration system 230 may include a High Efficiency Particulate Air (HEPA) filter, Ultraviolet (UV) light treated filter, Ultraviolet Germicidal Irradiation (UVGI), and/or Ultra-Low Particulate Air (ULPA), such that the air filtration system 230 filters air particles, bacteria and viruses exhaled by the patient (i.e., the patient's exhaled/expelled air). Other filtration systems, although not explicitly outlined herein, are contemplated by this disclosure. The air filtration system 230 may be portable so that it can be transported from one location to another location.

As described hereinabove and illustrated in FIG. 3, FIG. 7 and FIG. 8, the face shield 110 may include a port 114 that extends between the inner surface 111a and the outer surface 111b of the body 112 of the face shield 110. When a healthcare provider accesses the patient's orifices through the port 114, any airborne particles or liquids will be pulled by the air suction conduit 222 towards the second filters 224 and/or towards the air filtration system 230. While multiple ports 114 are illustrated in FIG. 3 and FIG. 8, it is contemplated that the face shield 110 may include a single port 114 (FIG. 7) at a location that provides access to the orifice the healthcare provider would like to examine, treat or operate on.

It is contemplated that one or more of the components of the protective equipment 100 (for example, the face shield and the extended member) may be suitable for one-time/single use, so that they are discarded after patient use. Alternatively, the components of the protective equipment 100 may be suitable for appropriate sterilization and disinfecting procedures after use.

FIGS. 10-11 illustrate the protective equipment 100 in use. As illustrated in FIG. 10, when a patient naturally breathes out, the air suction conduct 222 or hose 226 interrupts the radial movement of the air and pulls the air downwardly towards the first end 227a of the hose 226. Similarly, when a patient breathes air upwardly, the path of the patient's expelled air changes from an upward direction towards the direction of the first end 227a of the hose 226 (such as from the upward direction to the downward direction, as illustrated in FIG. 11.)

It is contemplated that one or more portions of the protective equipment 100 may include a fibrous material/fabric. The fibrous material may include a fibrous batt, such as a nonwoven batt, a nonwoven fabric, and other fibrous structures or composites, which generally include individual fibers or threads which are interlaid, but not in an identifiable manner as in a knitted fabric. In an embodiment, the fibrous material is needle punched to entangle the various fibers and provide Z-directional strength. As a result of the needle punching process, at least some fibers may extend substantially in the Z direction of the fabric may be mechanically entangled with each other. In some instances, the entangled fibers are generally wrapped around and/or intertwined with other fibers of the fabric. In addition, the entanglement of fibers enhances the dimensional stability and overall strength of the fabric, while imparting some degree of flexibility to the fabric, so that it may be shaped or molded into any desired shape.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A protective equipment comprising:
a face shield configured for being worn by a patient to minimize exposure of a healthcare worker to at least one of the patient's bodily fluids, bacteria and viruses, the face shield comprising a body having
an inner surface facing the patient,
an outer surface opposite the patient,
an upper peripheral edge,
a lower peripheral edge, and
a port positioned between the upper peripheral edge and the lower peripheral edge and extending between the inner surface and the outer surface,
wherein the positioning of the port provides entrance by one or more instruments through the face shield thereby providing access to the patient while protecting the healthcare worker from at least one of the patient's bodily fluids, bacteria and viruses; and
an extended member secured to the lower peripheral edge of the face shield, the extended member being configured to substantially inhibit or trap micro aerosolized particles from traversing the extended member.

2. The protective equipment of claim 1, wherein the face shield further comprises:
a barrier positioned in the port, the barrier comprising a periphery from which a plurality of deformable protrusions extends towards a centralized location of the port.

3. The protective equipment of claim 1, wherein the port comprises a plurality of ports, and each port of the plurality of ports is spaced apart from another port by a distance between about 0.5 cm and about 2.0 cm.

4. The protective equipment of claim 1, wherein the extended member comprises:
a first end secured to the lower peripheral edge of the face shield; and
a second end spaced apart from the first end,
wherein the first end is removably secured to the lower peripheral edge of the face shield, and the second end of the extended member comprises a securing mechanism configured to secure the extended member to a body portion of the patient.

5. The protective equipment of claim 1, wherein the extended member comprises a flexible and breathable material configured to trap aerosolized particles.

6. The protective equipment of claim 1, further comprising:
a shoulder harness couplable to the extended member, wherein the shoulder harness is frictionally or gravitationally secured to a portion of the extended member.

7. A protective equipment comprising:
a face shield configured for being worn by a patient to minimize exposure of a healthcare worker to at least one of the patient's bodily fluids, bacteria and viruses, the face shield comprising a body having
an inner surface facing the patient,
an outer surface opposite the patient,
an upper peripheral edge, and
a lower peripheral edge;
a port formed in the body, wherein the port is positioned between the upper peripheral edge and the lower peripheral edge and extends between the inner surface and the outer surface, and the positioning of the port provides entrance by one or more instruments through the face shield thereby providing access to the patient while protecting the healthcare worker from at least one of the patient's bodily fluids, bacteria and viruses; and
a barrier positioned in the port.

8. The protective equipment of claim 7, wherein the barrier comprises:
an upper barrier and a lower barrier and each of the upper barrier and the lower barrier includes a periphery secured within the port; and
a plurality of deformable protrusions extending from the periphery towards a centralized location of the port.

9. The protective equipment of claim 8, wherein the plurality of deformable protrusions comprises multiple flexible layers.

10. The protective equipment of claim 1, wherein the port comprises a plurality of ports, and each port of the plurality of ports is spaced apart from another port by a distance between about 0.5 cm and about 2.0 cm.

11. The protective equipment of claim 7, wherein the at least one port has an inner diameter of up to about 0.5 cm.

12. The protective equipment of claim 7, wherein at least a portion of the face shield is transparent or opaque.

13. A protective equipment comprising:
a face shield configured for being worn by a patient to minimize exposure of a healthcare worker to at least one of the patient's bodily fluids, bacteria and viruses, the face shield comprising a body having
an inner surface facing the patient,
an outer surface opposite the patient,
an upper peripheral edge having a first end and a second end, and
a circumferential edge portion extending between the first end and the second end of the upper peripheral edge, wherein at least a portion of the circumferential edge portion is secured to a body portion of the patient; and
an air flow system comprising
an air valve positioned adjacent the upper peripheral edge of the body, and
an air outlet positioned adjacent a lower portion/lower peripheral edge of the circumferential edge portion, wherein
the air valve is configured to receive and filter air from an environment external to the face shield, and the air outlet is configured to pull air expelled by the patient away from the patient's face and filter the expelled air.

14. The protective equipment of claim 13, wherein the air valve is a passive valve.

15. The protective equipment of claim 14, further comprising:
a first filter,
wherein the first filter is positioned in the air valve and filters the air from the environment external to the face shield prior to the filtered air being received into an environment internal to the face shield.

16. The protective equipment of claim 13, wherein the air outlet comprises:
an air suction conduit configured to pull the patient's expelled air away from the patient's face.

17. The protective equipment of claim 16, wherein the air suction conduit comprises a second filter configured to filter the patient's expelled air.

18. The protective equipment of claim 16, wherein the air suction conduit comprises:
a hose comprising a first end and a second end, wherein
the first end of the hose is connected to the lower portion of the circumferential edge portion of the body, and
the second end of the hose is connected to an air filtration system.

19. The protective equipment of claim 14, further comprising:
a port positioned between the upper peripheral edge and the circumferential edge portion and extending between the inner surface and the outer surface; and
a barrier positioned in the port,
wherein the positioning of the port provides entrance by one or more instruments through the face shield thereby providing access to the patient while protecting the healthcare worker from at least one of the patient's bodily fluids, bacteria and viruses, and
the barrier comprises a periphery from which a plurality of deformable protrusions extends towards a centralized location of the port.

20. The protective equipment of claim 13, further comprising:
an extended member secured to the lower peripheral edge of the face shield, the extended member being configured to substantially inhibit or trap micro aerosolized particles from traversing the extended member.
